(19) United States
(12) Patent Application Publication
(10) Pub. No.: US 2026/0043886 A1
(43) Pub. Date: Feb. 12, 2026

(54) COMPUTING LOCALIZATION UNCERTAINTY FOR DEVICES OPERATING IN DYNAMIC ENVIRONMENTS

(71) Applicant: Telefonaktiebolaget LM Ericsson (publ), Stockholm (SE)

(72) Inventors: Fernando dos Santos BARBOSA, Tullinge (SE); Adam MIKSITS, Solna (SE); Thomas LABOURDETTE-LIARESQ, Stockholm (SE); José ARAÚJO, Stockholm (SE); Clara GOMEZ BLAZQUEZ, Madrid (ES); Alejandra HERNANDEZ SILVA, Solna (SE); David UMSONST, Bromma (SE); Paula CARBÓ CUBERO, Stockholm (SE); Magnus LINDHÉ, Sundbyberg (SE)

(73) Assignee: Telefonaktiebolaget LM Ericsson (publ), Stockholm (SE)

(21) Appl. No.: 19/104,280

(22) PCT Filed: Aug. 14, 2023
(86) PCT No.: PCT/EP2023/072416

§ 371 Date: Feb. 17, 2025

Related U.S. Application Data
(60) Provisional application No. 63/398,007, filed on Aug. 15, 2022.

(51) Int. Cl. G01S 5/00; G01S 5/02

(52) U.S. Cl. CPC G01S 5/018; G01S 5/02524; G01S 5/0269; G01S 5/0278

(57) ABSTRACT

A first device can determine a map of an environment that includes a plurality of elements. The first device can further determine a localization uncertainty level (“LUL”) within the map. The first device can further determine a dynamicity level (“D_map”) for a portion of the plurality of elements in the map. The first device can further determine a new LUL (“LUL_new”) based on the LUL and the D_map. The first device can further provide the LUL_new to a second device in the environment.

### TECHNICAL FIELD

The present disclosure is related to wireless communication systems and more particularly to computing localization uncertainty for devices operating in dynamic environments.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

The robotics community has been making extensive progress towards increasing the level of autonomy of mobile robots, especially on the navigation task. For that, a system must be able to process information about the environment incoming via sensors, and make use of it in order to find and follow trajectories, so that a goal can be fulfilled. In the case of robotic navigation, it must be able to construct a representation of the environment, plan a collision-free trajectory from start to goal positions, and then follow it. Along the way, the robot must be able to localize itself, and sometimes even build/improve the map. Here is where the problem of localization-awareness started being addressed. The intuition is to enable the trajectory planning algorithm to take into account how well the system can localize itself along the plan, and so avoid going through areas where the chances of losing localization capabilities are high. The better the quality of the localization system of a device, the better performance the device application will typically exhibit, for example the better the localization performance the more accurate and faster a robot or an extended reality (“XR”) glasses user can move in an environment.

In some examples, deep-learning-based semantic segmentation algorithms are used in order to extract information about an environment. This information can be used by a motion planning algorithm so that a preference is given to regions of the environment that are rich in texture and visual features. In additional or alternative examples, trajectories can be determined that maintain good visual contact with feature rich areas of the environment. In additional or alternative examples, a map representation of the environment can be used for quantification of how well a robot is expected to localize itself in each region of the environment. An information theory metric (e.g., Fisher Information) can be used to calculate the quality of each visual feature of the map.

In some examples, the quality of the localization system is highly dependent on how well it can localize a map of that environment, which depends on how well a matching between the current sensor data acquired by the device can be compared/matched towards the map available at the device.

The quality of the localization can be negatively impacted by discrepancies between the available map and the current structure of the environment, where these discrepancies happen whenever the environment is modified (e.g., dynamic elements such as people, machines, and boxes became part of the map but they have moved and no longer exist in that location, or are now in a new location). The quality of the localization can also be negatively impacted due to the regions in the image not remaining static between two consecutive images, for example due to dynamic elements in the environment.

Understanding how well a device can localize in an environment can be key to determining the best path and orientation that a device should take in an environment when performing a task.

### SUMMARY

According to some embodiments, a method of operating a first device is provided. The method includes determining a map of an environment that includes a plurality of elements. The method further includes determining a localization uncertainty level (“LUL”) within the map. The method further includes determining a dynamicity level (“D_map”) for a portion of the plurality of elements in the map. The method further includes determining a new LUL (“LUL_new”) based on the LUL and the D_map. The method further includes providing the LUL_new to a second device in the environment.

According to other embodiments, a device, a network node, a communication device, a computer program, a computer program product, a non-transitory computer-readable medium, a host, or a system is provided to perform the above method.

Certain embodiments may provide one or more of the following technical advantages. In some embodiments, determining a localization uncertainty based on both static and dynamic elements increases the robustness on the calculation of localization uncertainty against (possibly) dynamic objects in the environment. By accounting for the possible movement of detected features, as well as for the SLAM algorithm being used, the proposed approach adjusts the predicted uncertainty levels in relevant areas of the environment. This way, a motion planning algorithm can find and plan trajectories that better account for such localization uncertainties, resulting in trajectories that are less likely to result in localization failures, and therefore are safer for the robot to follow.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a flow chart illustrating an example of operations for computing localization uncertainty for devices operating in dynamic environments in accordance with some embodiments;

FIGS. 3A-D are diagrams illustrating examples of a real world, map, LUL, and ESDF representation of a warehouse environment in accordance with some embodiments;

FIGS. 4A-C are images illustrating examples of pixel labeling in accordance with some embodiments;

FIG. 5 is a diagram illustrating an example of dynamic map elements relative to all map elements in accordance with some embodiments;

FIG. 6 is a diagram illustrating an example of segmentation based on pixel labeling in accordance with some embodiments:

FIGS. 7A-B are diagrams illustrating an example of the difference in planning based on a traditionally-determined LUL and the newly-determined LUL in accordance with some embodiments;

FIG. 8 is a diagram illustrating an example of a process to create a Fisher Information Field, which can be used to calculate and/or update LUL in accordance with some embodiments;

FIG. 9 is a flow chart illustrating an example of operations performed by a device in accordance with some embodiments;

FIG. 10 is a block diagram of a communication system in accordance with some embodiments;

FIG. 11 is a block diagram of a user equipment in accordance with some embodiments;

FIG. 12 is a block diagram of a network node in accordance with some embodiments;

FIG. 13 is a block diagram of a host computer communicating with a user equipment in accordance with some embodiments:

FIG. 14 is a block diagram of a virtualization environment in accordance with some embodiments; and

FIG. 15 is a block diagram of a host computer communicating via a base station with a user equipment over a partially wireless connection in accordance with some embodiments.

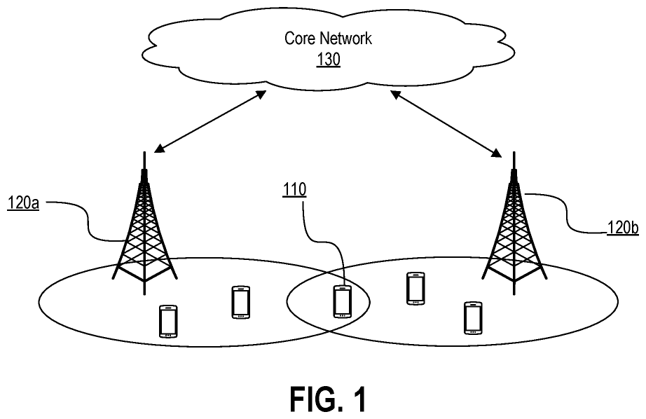

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There currently exist certain challenges. The robotics community has started to propose procedures to do the planning of the motion of the robot in an environment taking into account how well the device is expected to localize itself in the planned trajectory. The procedures rely on determining a localization uncertainty level for each pose (location and orientation) of the device in the environment. This determination is done offline by moving the device to every location in the environment, computing the map of the environment and then determining how well it can localize from each pose in that environment which provides a “localization uncertainty level” (“LUL”). However, these procedures assume a static environment and do not consider the fact that the environments may change due the movement of people and objects. Adapting the localization uncertainty level according to the dynamicity of the environment can be required to obtain good localization and hence a successful motion planning of the robot trajectory.

Certain aspects of the disclosure and their embodiments may provide solutions to these or other challenges. In some embodiments, the localization uncertainty level for a device in an environment can be determined by considering not only the static elements of an environment, but also any dynamic elements, such as objects, machines and humans. Such localization uncertainty level can then be used for determining in which locations and in which orientations the device is expected to localize the best, which can be a key element for determining the best path for a mobile device to follow in order to achieve the most precise localization.

In some embodiments, the localization uncertainty level is determined based on three data sources: the currently available environment map, the current sensor data captured by the device, and prior localization uncertainty level information. Dynamic elements in the environment map are detected and their dynamicity level is determined. Then, dynamic elements in the current sensor data captured by the device are detected and their dynamicity level is determined. The localization uncertain level is then adapted based on the location and level of dynamicity determined on the environment map and on the current sensor data.

In additional or alternative embodiments, a localization uncertainty level can be determined based on both static and dynamic elements of a scene, which is computed based on the information available in the current map of the environment, but also based on the current sensor information captured by the device when in operation.

In some examples, the uncertainty level is adapted based on dynamic information detected in the available offline map but also in the current sensor data during online operation, where the detection of dynamic information in the current sensor data is used to update the dynamic information of the offline map. This aspect makes sure that dynamic elements are taken into account in both the prior and current environment information.

In additional or alternative examples, since determining the dynamics of a scene is a heavy computational process, it can be done only to the regions of low uncertainty level, which are the high value poses where the device is expected to move, since high uncertainty level poses should be avoided even when dynamic elements are not part of it. This aspect can make the computation more efficient.

In additional or alternative examples, the uncertainty level is adapted according to the level of robustness that the localization algorithm running at the device has to dynamic elements in the environment. This aspect makes sure that if the device has a localization algorithm that cannot handle dynamics, even poses overlooking regions with low dynamics are regarded as poses with high uncertainty, while if the device has a localization algorithm that can handle dynamics well, the uncertainty level with higher dynamics are regarded as poses with lower uncertainty.

Various embodiments described herein allow the localization uncertainty level (“LUL”) for a device in an environment to be determined by considering not only the static elements of an environment, but also any dynamic elements, such as objects, machines and humans. Such localization uncertainty level can then be used for determining in which locations and in which orientations the device is expected to localize the best, which can be a key element for determining the best path for a mobile device to follow in order to maintain a good localization quality.

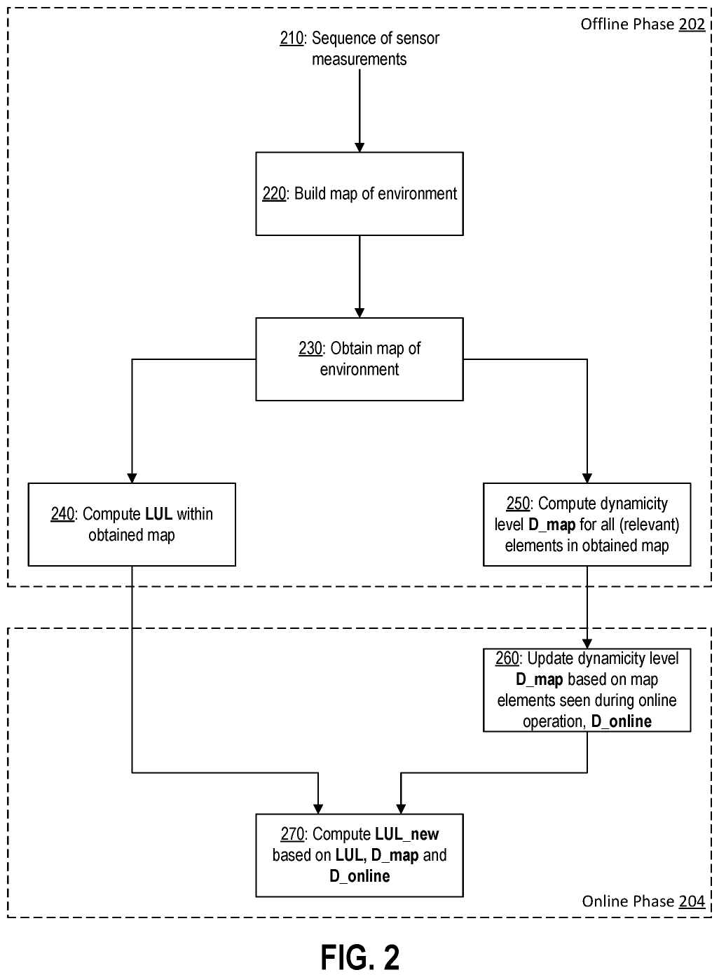

FIG. 2 illustrates operations performed by a device and/or system for determining a LUL for the device in an environment based on static and dynamic elements. In this example, the operations are divided between an offline phase 202 and an online phase 204. The offline phase 202 includes a period of time prior to the device operating within the environment and the online phase 204 includes a period of time during which the device operates within the environment. In some examples, the device is a robot moving and the environment is a warehouse. In other examples, the device is a vehicle and the environment is a set of roads. In other examples, the device is an aerial drone and the environment is a portion of the sky and ground. In additional or alternative examples, the device is autonomous or semi-autonomous. In additional or alternative examples, the device is a virtual reality (“VR”) device or extended reality (“XR”) device, which can collaborate with other device to maintain maps of certain environments.

At block 210 of FIG. 2, a sequence of sensor measurements are obtained and, in block 220, the measurements are used to determine an initial map of the environment. In some examples, blocks 210 and 220 are performed by the device. In additional or alternative examples, blocks 210 and 220 are performed by a central device or a system that collects measurements from various devices and sensors throughout the environment to determine an initial map of the environment.

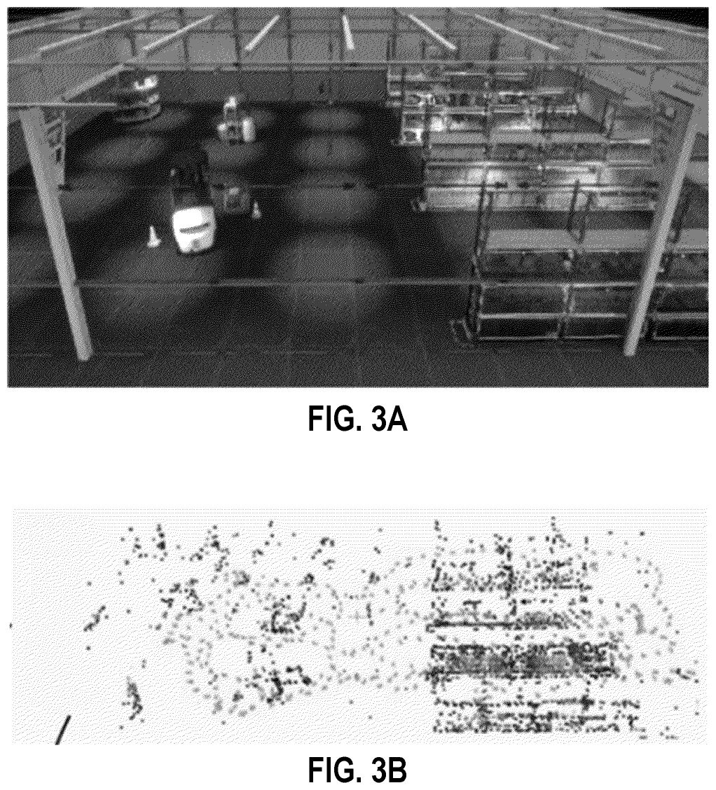

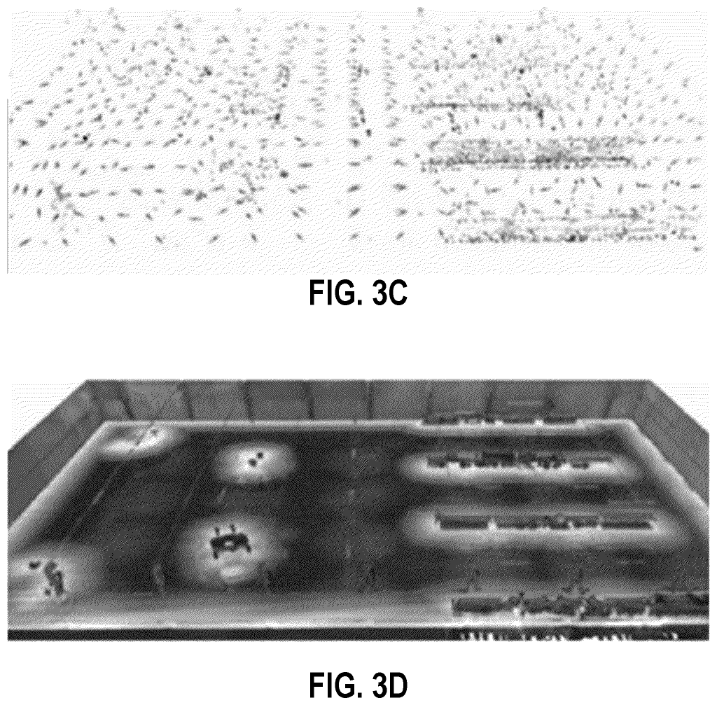

At block 230 of FIG. 2, the device obtains the map of the environment. In some embodiments, the operations include receiving the map. In some examples, receiving the map can include loading the map from memory. The map can be a representation of the environment, which can be used by the device to localize itself given its sensor data (e.g., images, Lidar, etc.). For a device with a camera, the map elements may be defined by 3D visual features, which represent the environment at those locations. A map can also include “keyframes” that are valuable images taken at poses q and are images for which a significant number of map elements are extracted from, among other properties. An example of a map is shown in FIGS. 3A-D. The map can be constructed from simultaneous localization and mapping (“SLAM”) (e.g., oriented FAST and rotated BRIEF SLAM (“ORBSLAM”)) or structure from motion (“SfM”) (e.g., COLMAP) methods.

A Euclidian signed distance field (“ESDF”) representation of a map can also be part of the map representation. The ESDF represents the distance from a location z in the map to the nearest obstacle.

FIG. 3A illustrates an example of a warehouse environment.

FIG. 3B illustrates an example of map elements extracted from the images recorded while mapping the warehouse environment.

FIG. 3C illustrates an example of optimal view directions in some positions in the warehouse environment based on the computed LUL.

FIG. 3D illustrates an example of an ESDF representation of the warehouse environment.

At block 240 of FIG. 2, the device computes a LUL within the map. In some embodiments, the operations include receiving a LUL within the map of the environment. In some examples, receiving the LUL can include loading the LUL from memory.

The LUL indicates how badly (e.g., via a value between [0,1]) the device is expected to localize itself within the map of the environment, for each device pose p in the map (position, orientation). The LUL can be computed as a function of the number of visible visual features observed at a given position and orientation of the device (e.g., if the device sees a large number of features from a given perspective, the LUL is low, while if a small number of features is seen from a given perspective the LUL is high). This LUL can be used to determine an optimal view direction, as is depicted in FIG. 2C. In some examples, the LUL is computed offline, where a device is moved in the environment and images are acquired for different positions and orientations which allows a map of visual features to be computed from which the LUL can be extracted for all positions and orientations.

At block 250 of FIG. 2, the device computes a dynamicity level (herein referred to as D_map) for some (e.g., relevant) elements in the map. In some embodiments, the operations include determining a level of environment dynamicity in the static map.

In some examples, the output of this operation is a dynamicity level D_map (x) for map information element at coordinates x, x∈R³, with D_map∈{0,1} or D_map∈[0,1]. A map information element at coordinates x can be a visual feature, where such visual feature has a level of dynamicity D_map(x).

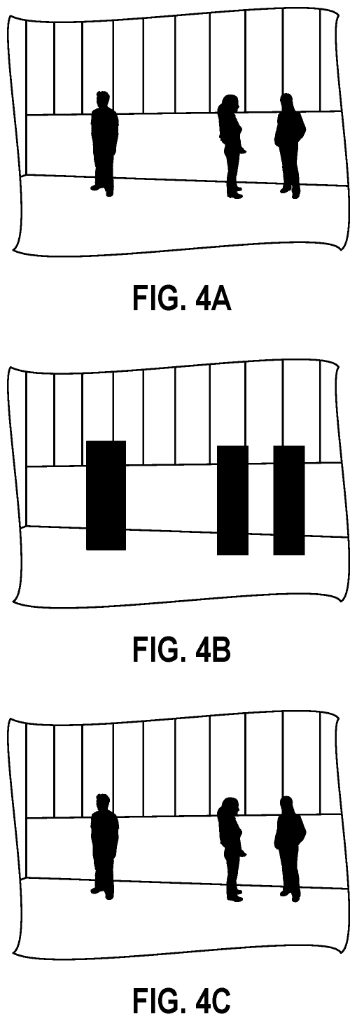

In additional or alternative examples, the exhaustive option is to compute, for each map information element, its level of dynamicity. For each image used to compute the map information elements, a segmentation algorithm (e.g., MaskRCNN) can be applied to determine the object label for each pixel in the image (see e.g., FIGS. 4A-C), and set the label of the map information element according to the determined object label. Each map information element can be classified according to the dynamicity of its label. For example, for a label corresponding to a static/dynamic object, one can classify it as a binary label 0/1 (static/dynamic): or a classification according to its level of dynamicity ([0,1], where 0) means static and the closer to 1 the more dynamic the object is). One example of a method to classify the level of dynamicity of an obstacle is to first have access to a database of object classes (such as in MaskRCNN) along with a value within [0,1] relating each class to how dynamic it is expected to be. For example, structural elements such as wall and pillars could receive ‘0’ since they are static elements, large shelves could receive ‘0.4’ as they hardly ever move, boxes in these shelves could be ‘0.7’, and humans and mobile robots ‘0.9’. Then, when using our method, the output of an object detection and instance classification algorithm can be used to search in a look-up table for the dynamic level of that instance. Dynamicity of identified objects can be verified by adding a tracker that tracks objects in the mapping stage. However, since an object that is static during mapping might still have moved between the mapping phase and task execution, these objects could still be unreliable when planning, so the dynamicity has to be updated online as well.

In additional or alternative examples, computation power can be saved by determining the level of dynamicity for the locations in the map where the LUL is below a desired threshold, which means that it is only applied to map regions where the device is already expected to move since they are regions where the localization uncertainty is low. In some examples, for each image obtained from a pose where the LUL is below a desired threshold, apply a segmentation algorithm (e.g. MaskRCNN) and determine the object label for each pixel in the image (see e.g., FIG. 4C where pixels containing a human have been labeled) and set the label of the map information element according to the determined object label. The threshold can be determined experimentally. In additional or alternative examples, the label can be transformed according to the dynamicity which is to give a number value to the label according to its dynamicity. For example, as either a dynamic or a static object (binary label 0/1 as static/dynamic), or as a level of dynamicity ([0,1], where 0 means static and the closer to 1 the more dynamic the object is).

FIGS. 4A-C shows the labeling of pixels in an image (FIG. 4A) using either instance segmentation (FIG. 4C) or a bounding box (FIG. 4B). Despite the accuracy of the segmentation, the top of the heads and some parts of the shoes are not covered, which can result in mislabeled map elements in case they were extracted from these parts of the humans. The bounding box method instead captures more than just the map elements from the object, requiring an extra step to ensure only dynamic map elements are labelled as dynamic.

In additional or alterative examples, in devices with constrained resources, computation can be off-loaded to a more powerful computing device, such as edge and cloud computers. The device can determine if the data required to compute the dynamicity level is present in the distributed computing device. If it is already present (possibly in a case where the constrained device had already downloaded the data), then the device can proceed to perform the operation. Otherwise, the device may upload the data to the computing device. Once the powerful device has access to the data required, it performs the operation. It then communicates back with the constrained device, and sends the results of the operation (e.g., dynamicity level D_map(x) for map information element at coordinates x, x∈R³).

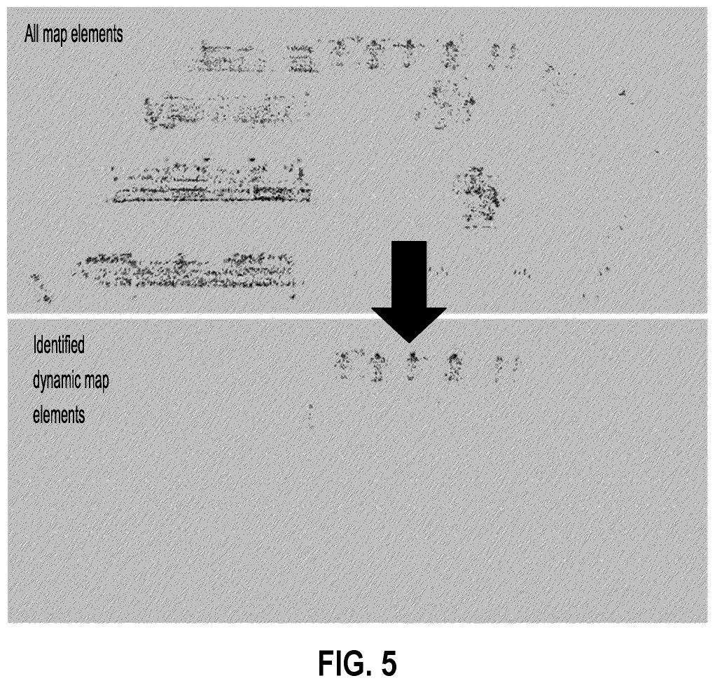

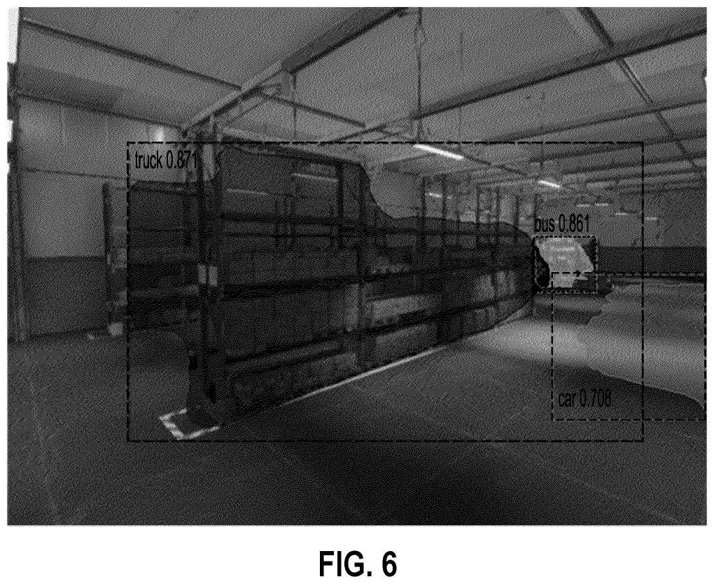

Current state-of-the-art segmentation algorithms may not segment the object precisely (e.g., as illustrated in FIGS. 4A-C, where some pixels of the human were not properly labeled and FIG. 6 for the segmentation of shelves). This creates a problem since map elements may be misclassified in terms of their dynamicity, and usually pixels in the corners of objects are the ones being selected as map elements by the mapping algorithms (e.g., SLAM/SfM). If this is still a problem in practice in the future (since in the future segmentation algorithms may become better), one could instead use an object detector to be less conservative with the pixel classification. By using a voting scheme that labels map elements as dynamic only if the objects they came from were classified as dynamic in enough images, non-dynamic map elements that might be inside some of the bounding boxes can be rejected, assuming the dynamic objects were seen from enough viewpoints. A result of this classification and voting can be seen in FIG. 5.

FIG. 5 is an example illustration of all map element in a map and the result of identifying dynamic map elements with a bounding box procedure. As can be seen, the map elements identified on the six humans in the top of the map were labelled as dynamic, together with some map elements close to them that were misclassified.

FIG. 6 is an example illustration of the mismatch between the output of the segmentation and detection algorithm and the real object which should have been segmented/bounded by a box. The confidence in the classification is also shown in the left corners of the bounding boxes.

Since the map element at location x is determined using potentially several images as the device captures that location from various perspectives, post-processing is required to determine D_map(x). One way to address this problem is that this is performed using a voting system where D_map(x) is given by the dynamicity level which has the largest representation given all images N used to create the map element at location x. Another way to address this problem is to have the device receive a level of confidence from the segmentation algorithm regarding its classification, and based on that utilize the most confident result from all set of images to determine D_map(x).

At block 260, the device (now in the online phase 204) updates the dynamicity level of D_map based on map elements seen (e.g., measured or captured via a camera) during online operation (the updates to the dynamicity level can be referred to as D_online). In some embodiments, the operations include the device determining a level of environment dynamicity in an online environment.

In some examples, given the current acquired sensor data by the device, the device determines dynamic elements (e.g., objects that can move in the environment between two time instances) using the segmentation methods and validates if they are present in the map and are in the same location (e.g., known elements in same location), if they are present in the map but have changed their location (e.g., known elements in a new location), or if they are new dynamic elements (e.g., unknown elements). This determination is performed by a search based on the map element label and corresponding map coordinate x.

In additional or alternative examples, a known element is considered to be in the same location if a map element labeled l1 is still present at coordinate x1 in the current environment vs what was indicated in the map obtained in block 230.

In additional or alternative examples, a known element is considered to be in a new location if an element label l1 is present in coordinate x1 in the current environment but it is present in coordinate x2 in the initial map (obtained in block 230). This may require an assumption that either the elements are unique (so there cannot be the case that the current observed object is a duplicate of the same object which is still in the previous location), or that the device has already visited location x2 to make sure that such element is no longer in location x2 but it is now in location x1. If the device has not visited location x2 yet, then location x2 may be set as “uncertain” and a device must see location x2 to confirm the above at a later stage.

In additional or alternative examples, an element can be considered an unknown elements if an element label 11 is present in coordinate x1 in the current environment but it is not present in any coordinate x in the initial map (or a previously determined map).

Dynamicity of a map element at locations x can be defined as D_online(x) with D_online∈{0,1} or D_online∈[0,1].

In some examples, a known element being in the same location can mean that the object has not moved and so this area in the map will likely result in low dynamicity since the object has remained static. A result is that D_online(x) at such locations x could be set to 0 or a low value. Considering that the device may visit this location several times during operation, an alternative implementation to setting the value D_online(x) to a fixed value, is to instead increment D_online(x) for every visit to build confidence incrementally that a dynamic element is indeed at (and potentially remaining at) a location.

In additional or alternative examples, a known element being at a new location can mean that the object has moved within the map from location x_prior to the current location x. Then the dynamicity level has to be adapted at x_pior in the D_map(x_prior), and D_online(x) should be set to the level of dynamicity determined for the object. Considering that the device may visit this location several times during operation, an alternative implementation to setting the value D_online(x) and D_map(x_prior) to a fixed value includes incrementing D_online(x) and D_map(x_prior) for every visit to build confidence incrementally that a dynamic element is indeed at a location (or decrementing to indicate that the element is moving between locations).

In additional or alternative examples, identifying an unknown elements means that a new object is in location x, so both D_map(x) and D_online(x) should be updated. Considering that the device may visit this location several times during operation, an alternative implementation to setting the value D_online(x) and D_map(x_prior) to a fixed value, includes incrementing D_online(x) and D_map(x_prior) for every visit to build confidence incrementally that a dynamic element is indeed at said location.

In additional or alternative examples, the device can consider extra sources of information to determine the dynamicity of the environment in certain locations. For example, extra sensors in the environment or from sensors in devices carried by machines or people in the environment can provide information of D_online(x).

At block 270, the device computes a new LUL (sometimes referred to herein as LUL_new) based on LUL (computed in block 240), D_map (obtained in block 230), and D_online (determined in block 260). In some examples, the device adapts the LUL according to level of dynamicity in a static map and the online (active) environment.

In some examples, the device can have obtained D_map(x), D_online(x), and LUL(p), so that it can now compute a new LUL_new(p) which can then be used, for example, for determining the motion trajectory of a robot in the environment. D_map and D_online are respective to map elements and their locations x, while LUL is given with the device pose p in the map, from where the device observes the map elements.

The computation of the LUL_new(p) can be performed in various ways.

In some examples, the LUL can be increased if a significant number of map elements determined both online and in the previous map, have dynamicity that is larger than a desired value, otherwise the LUL remains constant. An implementation of this example may be illustrated as:

$$\{ \begin{matrix}{LUL}_{new} ( p ) = LUL ( p ) * ( 1 + N / M ) , if N \geq N min \\ {LUL}_{new} ( p ) = LUL ( p ) , if N < N min\end{matrix} .$$

where M is the number of map elements at coordinates x visible from pose p, N is the number of map elements in M that are classified as dynamic, i.e. for which either D_map(x) or D_online(x) are greater than a threshold\delta, and Nmin is the minimum number of dynamic features for which an increase in LUL should take place. The threshold value\delta could be defined by the application which will use LUL_{new}(p) to take decisions, as for example the robot motion planner may define a desired threshold on the dynamics of the environment.

In an additional or alternative examples, LUL is adapted directly according to the level of dynamicity of the map elements. This differs from the previous example in the sense that the previous example, LUL is adapted according to the number of elements classified as dynamic. In this example, highly dynamic elements can have a higher degree of influence on LUL_new than slightly dynamic elements. An implementation of this example may be illustrated as:

$${LUL}_{new} ( p ) = LUL ( p ) * ( 1 + K * {\sum }_{i ∈ D} {D}_{map} ( {x}_{i} ) ) ,$$

where D is the set of map elements x visible from p, and K is a scaling parameter. Visibility can be determined using ESDF and depth maps.

For subsequent iterations of the process illustrated in FIG. 2, the operations (described above) can be applied by using LUL_{new}(p) as LUL(p). In some examples, there can be a need to decrease LUL_{new}(p) after it has been increased if no or fewer dynamic elements are visible at pose p (for which either D_map(x) or D_online(x) are greater than a threshold). That could be done as follows as the

$$max ( {LUL}_{new} ( p ) = LUL ( p ) * β , if N < N min , {LUL}^{original} ( p ) ) ,$$

which means that the LUL can be decreased to as low as the original LUL obtained during the offline phase 202.

In additional or alternative embodiments, the computation of the LUL is performed according to how well the localization algorithm running in the device can handle dynamicity, since different algorithms can handle dynamicity in various degrees. For example, a simple but energy efficient SLAM algorithm like ORBSLAM is not so robust to dynamics, while a more complex algorithm, but also more demanding, such as DynaSLAM is more robust to dynamicity. Given the SLAM robustness, a factor (alpha) can be determined in [0,1] where the closer to 0 the more robust the SLAM is to dynamicity. The level of robustness can be provided by the SLAM algorithm provider, or can be established via experiments. In this case, the LUL_new(p) can be computed as follows:

$$LUL\_new ( p ) = LUL ( p ) * ( 1 + N / M )$$

where N is the number of map elements visible from the camera pose p for which {D_map(x)*\alpha or D_online(x)*\alpha}>threshold, for all map elements at coordinates x, and M is the total number of map elements visible from the camera pose p.

In additional or alternative embodiments, online information may not be considered when determining LUL_new(p). Instead, LUL_new(p) is determined based only on LUL and D_map. The computation of LUL_new(p) may only take the D_map into account to determine N.

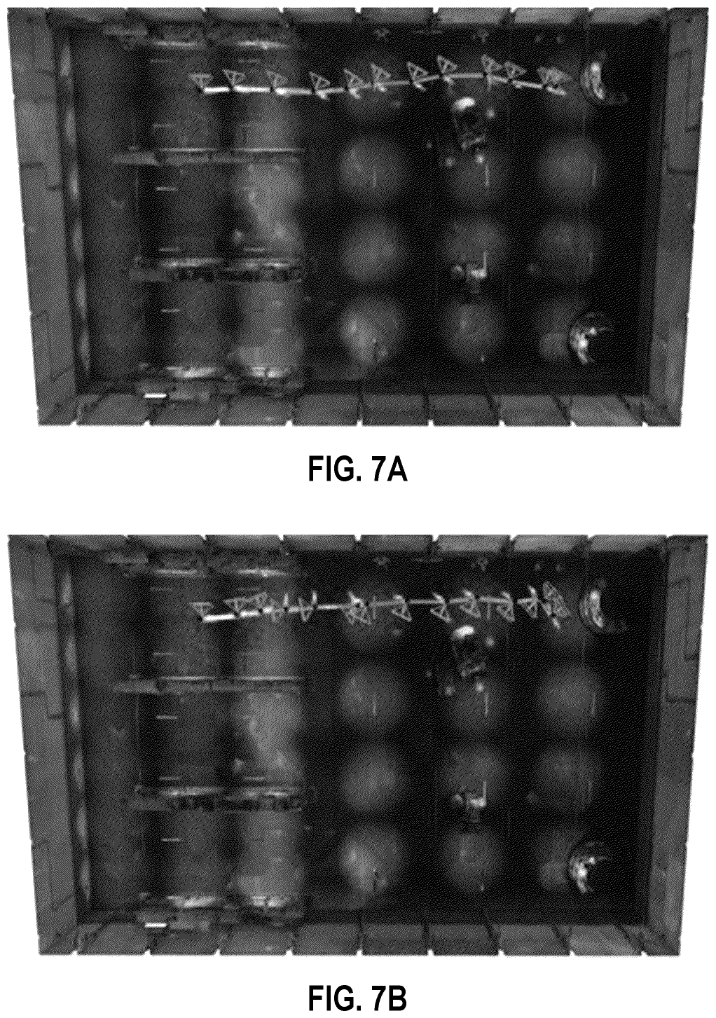

In additional or alternative embodiments, the device or system can make use of the LUL_new to, for example, plan the trajectory of a robot, where such planning will attempt to determine the path and orientation of the robot which achieves the minimal LUL_new. FIGS. 7A-B illustrate the advantage of having access to knowledge of dynamicity when estimating the localization uncertainty level in an environment with potentially dynamic objects.

FIGS. 7A-B include example illustrations of resulting path plans when taking either only LUL into account (FIG. 7A), or the LUL_new into account (FIG. 7B), estimated based on the map elements shown in FIG. 5. The triangles represent camera view directions from positions along the planned paths. The path in FIG. 7A clearly faces the humans in the top right corner, whereas the path in FIG. 7B actively faces away from them. The resulting plans when using LUL and LUL_new differ, where the view directions change in the second case based on the knowledge that facing the potentially dynamic humans would increase the uncertainty. These positions in the paths were then used for localizing, but with the humans removed from the simulation environment. This caused an increase of the localization failure rate when using the plan based on LUL, compared to the plan based on LUL_new.

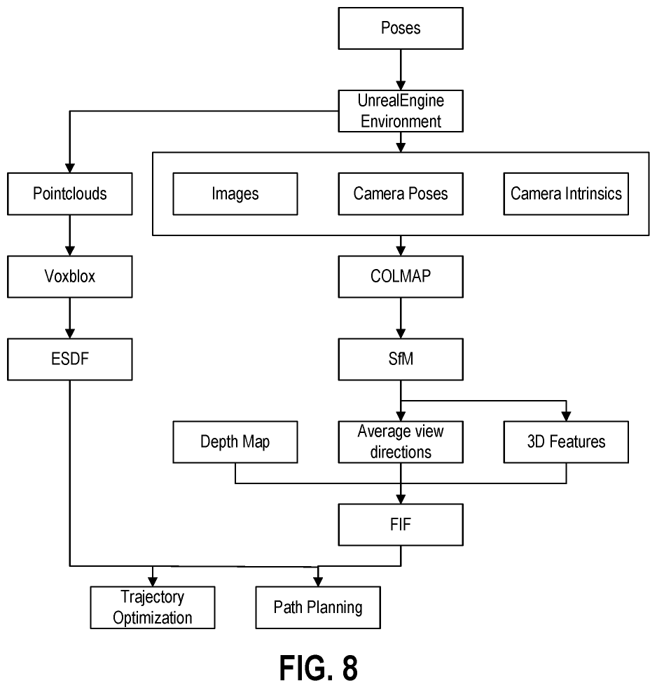

In additional or alternative embodiments, a state-of-the-art algorithm to calculate the localization uncertainty level of an environment can be used when determining LUL_new. In some examples, Fisher Information Fields (“FIF”), which are based on information theory (Fisher Information Matrices) and directly represent the expected uncertainty levels can be used. FIG. 8 illustrates an example of the process to create a FIF. In short, a simulation environment is created using UnrealEngine, and a simulated unmanned aerial vehicle (“UAV”) is manually controlled to navigate such environment while images are captured. From the images, COLMAP and SfM are used to extract a 3D feature map, and point clouds are used in Voxblox to compute ESDFs, which are important for collision detection in motion planning algorithms. From the 3D feature map, the average view directions of these features, and using information theory, the FIF is calculated.

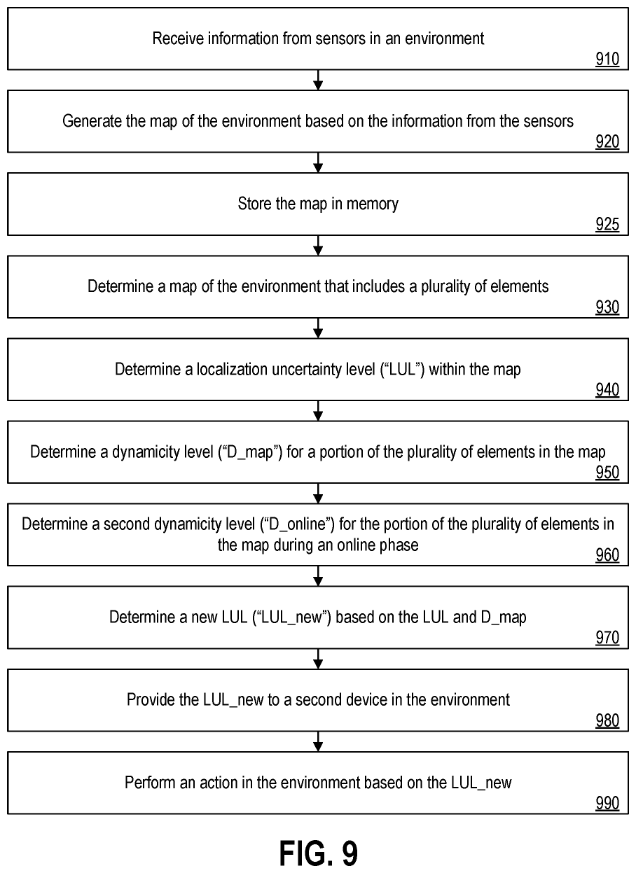

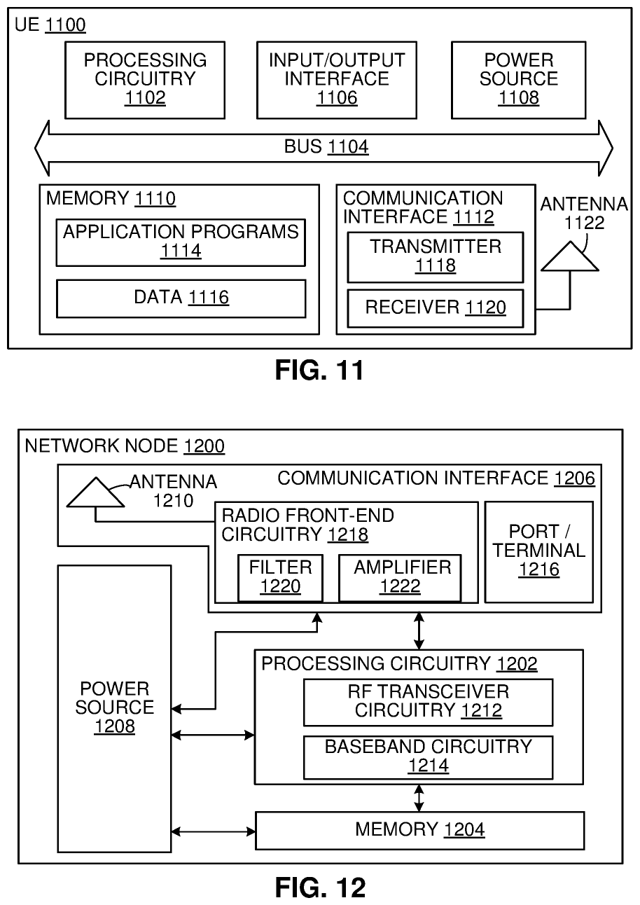

In the description that follows, while a device may be any of a network node 1010A-B, HUB 1014, Core network node 1008, wireless device 1012A-B, wireless devices UE 1012C-D, UE 1100, network node 1200, virtualization hardware 1404, virtual machines 1408A, 1408B, network node 1504, or UE 1506, the UE 1100 (also referred to herein as communication device 1100) shall be used to describe the functionality of the operations of the device. Operations of the communication device 1100 (implemented using the structure of the block diagram of FIG. 11) will now be discussed with reference to the flow chart of FIG. 9 according to some embodiments of inventive concepts. For example, modules may be stored in memory 1110 of FIG. 11, and these modules may provide instructions so that when the instructions of a module are executed by respective communication device processing circuitry 1102, processing circuitry 1102 performs respective operations of the flow chart.

FIG. 9 illustrates operations performed by a first device. In some embodiments, the operations allow for computation of a localization uncertainty for a second device operating in an environment with dynamic elements. In some examples, the first device includes the second device. The first device can include an unmanned aerial vehicle, a drone (e.g., a robot), or a self-driving vehicle. In other examples, the first device is a centralized device or cloud device that provides information/instructions to the second device.

At block 910, processing circuitry 1102 receives, via communication interface 1112, information from sensors in the environment.

At block 920, processing circuitry 1102 generates the map of the environment based on the information from the sensors.

At block 925, processing circuitry 1102 stores the map in memory.

At block 930, processing circuitry 1102 determines a map of the environment that includes a plurality of elements. In some embodiments, determining the map includes determining the map during an offline phase. The offline phase can be a period of time during which the second device is not actively operating in the environment. In some examples, the map is retrieved from the memory. In other examples, the map is received from a third device (e.g., a remote controller).

At block 940, processing circuitry 1102 determines a LUL within the map. In some embodiments, determining the LUL includes determining the LUL during the offline phase. In some examples, the first device calculates the LUL based on the map. In other examples, the LUL is received from a third device (e.g., a remote controller).

At block 950, processing circuitry 1102 determines a D_map for a portion of the plurality of elements in the map. In some embodiments, determining the D_map includes determining the D_map during the offline phase. In some examples, the D_map is received from a third device (e.g., a remote controller).

In some embodiments, determining the D_map for the portion of the plurality of elements in the map includes determining the D_map for relevant elements of the plurality of elements in the map. In some examples, determining the D_map for relevant elements includes determining the D_map for elements associated with portions of the map in which the LUL is below a threshold value.

In additional or alternative embodiments, determining the D_map includes determining a value for each element of the portion of the plurality of elements, the value indicating a probability that the element will be at the same location within the map at a point in time in the future.

At block 960, processing circuitry 1102 determines a D_online for the portion of the plurality of elements in the map during an online phase. In some embodiments, determining the D_online includes determining the D_online based on an element of the plurality of elements being detected by the second device during the online phase at a location in the map that is not associated with the element.

In additional or alternative embodiments, determining the D_online includes determining the D_online based on an element of the plurality of elements not being detected by the second device during the online phase at a location in the map associated with the element.

In additional or alternative embodiments, determining the D_online includes determining the D_online based on an unknown element being detected by the second device during the online phase at a location in the map, the unknown element not being within the portion of the plurality of elements.

In additional or alternative embodiments, determining the D_online includes increasing or decreasing an indicator associated with each element of the portion of the plurality of elements, the indicator indicating a probability that a respective element is at a location in the map associated with the respective element.

In additional or alternative embodiments, determining the D_online includes determining the D_online based on information received from at least one of: sensors in the environment; other devices in the environment; and user input.

At block 970, processing circuitry 1102 determines a LUL_new based on the LUL and D_map. In some embodiments, determining the LUL_new includes determining the LUL_new during an online phase. The online phase can be a period of time during which the second device is actively operating in the environment.

In additional or alternative embodiments, determining the LUL_new includes determining the LUL_new based on the D_online.

In additional or alternative embodiments, determining the LUL_new includes determining a number of dynamic elements in the map based on D_map and D_online and determining the LUL_new by adjusting the LUL based on whether the number of dynamic elements exceeds a threshold value. In some examples, determining the LUL_new includes determining the LUL_new according to:

$$\{ \begin{matrix}{LUL}_{new} ( p ) = LUL ( p ) * ( 1 + \frac{N}{M} ) , if N \geq N min \\ {LUL}_{new} ( p ) = LUL ( p ) , if N < N min\end{matrix} ,$$

where M is the number of map elements at coordinates x visible to the second device from pose, p, of the second device, and N is a number of elements in the plurality of elements, M, that are classified as dynamic.

In additional or alternative embodiments, determining the LUL_new includes determining the LUL_new based on an indication of how well an algorithm used by the first device for determining the LUL handles dynamicity.

At block 980, processing circuitry 1102 provides the LUL_new to a second device in the environment. In some examples, the first device transmits the LUL_new to the second device to allow the second device to perform actions in the environment.

At block 990, processing circuitry 1102 performs an action in the environment based on the LUL_new. In some embodiments, performing the actions includes autonomously navigating the environment using a route determined based on the LUL_new.

Various operations illustrated in FIG. 9 may be optional in respect to some embodiments.

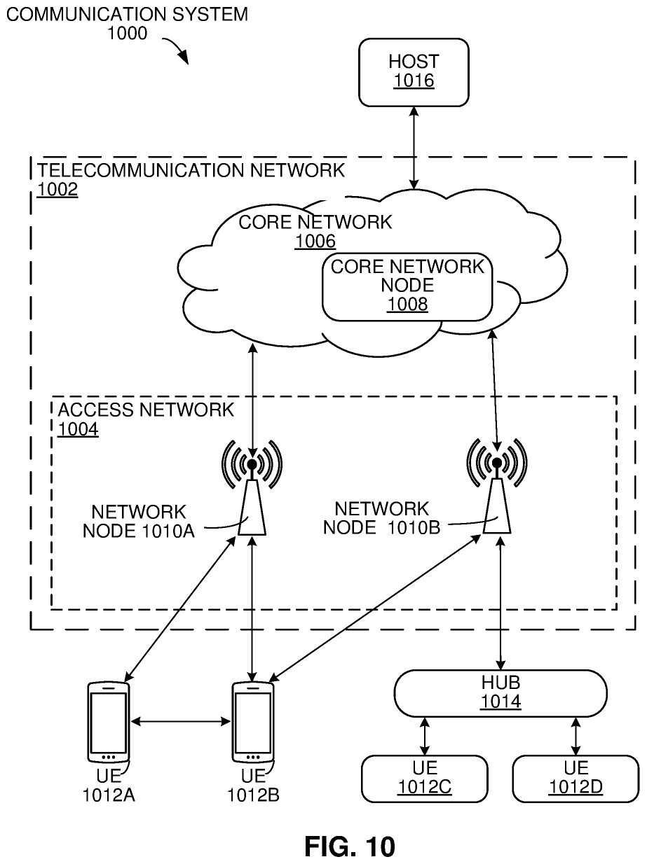

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. Moreover, as will be appreciated by those of skill in the art, the network nodes 1010 are not necessarily limited to an implementation in which a radio portion and a baseband portion are supplied and integrated by a single vendor. Thus, it will be understood that the network nodes 1010 may include disaggregated implementations or portions thereof. For example, in some embodiments, the telecommunication network 1002 includes one or more Open-RAN (ORAN) network nodes. An ORAN network node is a node in the telecommunication network 1002 that supports an ORAN specification (e.g., a specification published by the O-RAN Alliance, or any similar organization) and may operate alone or together with other nodes to implement one or more functionalities of any node in the telecommunication network 1002, including one or more network nodes 1010 and/or core network nodes 1008.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 1010 facilitate direct or indirect connection of user equipment (UE), such as by connecting wireless devices 1012a, 1012b, 1012c, and 1012d (one or more of which may be generally referred to as UEs 1012) to the core network 1006 over one or more wireless connections. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

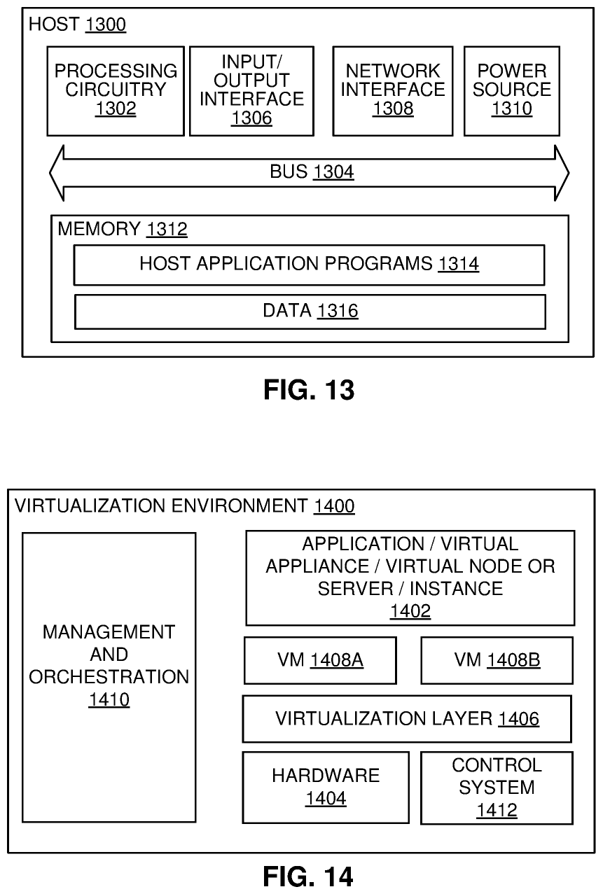

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1400 includes components defined by the O-RAN Alliance, such as an O-Cloud environment orchestrated by a Service Management and Orchestration Framework via an O-2 interface.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

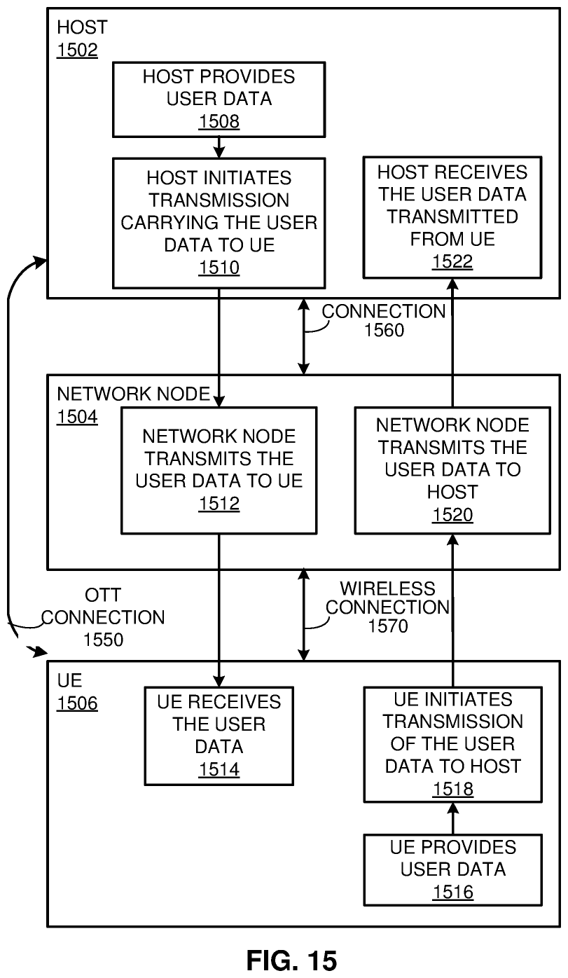

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may increase the robustness on the calculation of localization uncertainty against (possibly) dynamic objects in the environment. By accounting for the possible movement of detected features, as well as for the SLAM algorithm being used, the proposed approach adjusts the predicted uncertainty levels in relevant areas of the environment. This way, a motion planning algorithm can find and plan trajectories that better account for such localization uncertainties, resulting in trajectories that are less likely to result in localization failures, and therefore are safer for the robot to follow.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a first device, the method comprising:
determining a map of an environment that includes a plurality of elements;
determining a localization uncertainty level, LUL, within the map;
determining a dynamicity level, D_map, for a portion of the plurality of elements in the map;
determining a new LUL, LUL_new, based on the LUL and the D_map; and
providing the LUL_new to a second device in the environment.

2. The method of claim 1, wherein determining the map comprises determining the map during an offline phase, the offline phase being a period of time during which the second device is not actively operating in the environment,
wherein determining the LUL comprises determining the LUL during the offline phase,
wherein determining the D_map comprises determining the D_map during the offline phase, and
wherein determining the LUL_new comprises determining the LUL_new during an online phase, the online phase being a period of time during which the second device is actively operating in the environment.

3. The method of claim 2, wherein the D_map is a first dynamicity level for a portion of the plurality of elements in the map,
the method further comprising:
determining a second dynamicity level, D_online, for the portion of the plurality of elements in the map during the online phase,
wherein determining the LUL_new comprises determining the LUL_new based on the D_online.

4. The method of claim 3, wherein determining the D_online comprises determining the D_online based on one or more of:
an element of the plurality of elements being detected by the second device during the online phase at a location in the map that is not associated with the element;
an element of the plurality of elements not being detected by the second device during the online phase at a location in the map associated with the element;
an unknown element being detected by the second device during the online phase at a location in the map, the unknown element not being within the portion of the plurality of elements;
increasing or decreasing an indicator associated with each element of the portion of the plurality of elements, the indicator indicating a probability that a respective element is at a location in the map associated with the respective element; and
information received from at least one of:
sensors in the environment;
other devices in the environment; and
user input.

5-8. (canceled)

9. The method of claim 3, wherein determining the LUL_new comprises:
determining a number of dynamic elements in the map based on D_map and D_online; and
determining the LUL_new by adjusting the LUL based on whether the number of dynamic elements exceeds a threshold value.

10. The method of claim 3, wherein determining the LUL_new comprises determining the LUL_new according to:
$$\{ \begin{matrix}{LUL}_{new} ( p ) = LUL ( p ) * ( 1 + \frac{N}{M} ) , if N \geq N min \\ {LUL}_{new} ( p ) = LUL ( p ) , if N < N min\end{matrix}$$
where M is the number of map elements at coordinates x visible to the second device from pose, p, of the second device, and N is a number of elements in the plurality of elements, M, that are classified as dynamic.

11. The method of claim 3, wherein determining the LUL_new comprises determining the LUL_new based on an indication of how well an algorithm used by the first device for determining the LUL handles dynamicity.

12. The method of claim 1, wherein the first device comprises the second device,
the method further comprising:
performing actions in the environment based on the LUL_new.

13. The method of claim 12, wherein performing the actions comprises autonomously navigating the environment using a route determined based on the LUL_new.

14. The method of claim 12, wherein determining the map comprises receiving the map from a third device,
wherein determining the LUL comprises receiving the LUL from the third device, and
wherein determining the D_map comprises receiving the D_map from the third device.

15. The method of claim 12, further comprising:
transmitting an indication of an element of the plurality of elements detected by the first device during an online phase to a third device.

16. The method of claim 12, wherein the first device comprises at least one of:
an unmanned aerial vehicle;
an unmanned ground vehicle;
a virtual reality, VR, device;
an extended reality, XR, device;
a drone; and
a self-driving vehicle.

17. The method of claim 1, wherein the first device is separate from the second device,
the method further comprising:
transmitting at least one of: the map, LUL, and D_map to the second device.

18. The method of claim 1, further comprising:
receiving information from sensors in the environment;
generating the map of the environment based on the information from the sensors; and
storing the map in a memory,
wherein determining the map comprises retrieving the map from the memory.

19. The method of claim 1, wherein determining the D_map for the portion of the plurality of elements in the map comprises determining the D_map for relevant elements of the plurality of elements in the map.

20. The method of claim 19, wherein determining the D_map for relevant elements comprises determining the D_map for elements associated with portions of the map in which the LUL is below a threshold value.

21. The method of claim 1, wherein determining the D_map comprises determining a value for each element of the portion of the plurality of elements, the value indicating a probability that the element will be at the same location within the map at a point in time in the future.

22. A device operating in association with an environment that includes a dynamic element, the device comprising:
processing circuitry; and
memory coupled to the processing circuitry and having instructions stored therein that are executable by the processing circuitry to cause the device to perform operations comprising the operations of claim 1.

23. (canceled)

24. A computer program product comprising a non-transitory storage medium including program code to be executed by processing circuitry of a device operating in an environment that includes a dynamic element, whereby execution of the program code causes the device to perform operations comprising the operations of claim 1.

25. A non-transitory computer-readable medium having instructions stored therein that are executable by processing circuitry of a device operating in an environment that includes a dynamic element, to cause the device to perform operations comprising the operations of claim 1.
